(19) United States
(12) Patent Application Publication
(10) Pub. No.: US 2009/0030659 A1
(43) Pub. Date: Jan. 29, 2009

(54) SEPARABLE INTEGRATION VIA HIGHER-ORDER PROGRAMMING

(75) Inventors: Brian C. Beckman, Newcastle, WA (US); Henricus Johannes Maria Meijer, Mercer Island, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/781,519

(22) Filed: Jul. 23, 2007

(51) Int. Cl. G06F 17/10

(52) U.S. Cl. 703/2

(57) ABSTRACT

Separable integration is provided for simulation contexts where modeling and integration can be considered separately when programmatically implementing the simulations, for example. Thus, modeling concepts can be defined relating to the simulation, and integration of the modeling concept can happen separately to provide more variety to meet modeling specifications. In one embodiment, a state-space form equation can be computed for a modeling concept equation (an equation of motion, for example) and an integration scheme can be applied to the state-space form equation regardless of the modeling equation from which it was computed. In this regard, integration can be focused on to provide a plurality of schemes for different contexts, for example.

### BACKGROUND

The evolution of computers and networking technologies from high-cost, low performance data processing systems to low cost, high-performance communication, problem solving, and entertainment systems has allowed computers to be increasingly utilized in the context of simulation. For example, computers can be used to simulate many activities including circuit data flow, spacecraft orbit, computer-aided design/computer-aided manufacturing (CAD/CAM), network communication analysis, flight/driving simulation, health monitoring, and the like. Additionally, video games are, in effect, simulators as well, though the precision requirements can vary from the former simulators.

Simulation can require consideration of two concepts in facilitating desirable simulation scenarios on a device, for example. Modeling concepts can provide equations of motion that define the physical aspects of how things move around in real-time to provide simulation thereof. There can be a plurality of such concepts or equations that can be used in a given context depending on fidelity and performance requirements. In the context of reproducing real-time events, integration is another concept that can be required to solve the equations of motion in different contexts. For example, using a computer to simulate a real activity can be challenging due to processing power, bandwidth limitations, etc. Thus, integration can define a trade-off between stability and performance where more stable application to an equation can require more processing power making it more difficult to achieve desired performance.

Simulation devices and program applications merge the concepts due to the dichotomy of imperative and functional systems. Programming languages are typically imperative (such as object-oriented languages, for example), and programs written in the languages combine modeling concepts with integration concepts such that changing a portion of a simulation algorithm effectuates changes to both the modeling and integration concepts. This is due to the fact that imperative systems have no notion of higher-order concepts (such as on a time-basis, for example) such to be able to separate the integration concepts or schemes from the modeling concepts.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Separable integration is provided for imperative contexts (such as object-oriented programming languages, for example) such that integration schemes can be separated from modeling concepts. This can allow a simulation, or developer thereof, to focus on integration concepts without having concern for accuracy or integrity of modeling concepts. To this end, integration schemes can be changed or modified without having to change or modify modeling concepts. Separation of integration also allows for parameterization of the integration schemes to tune the application thereof for different contexts.

In one embodiment, a modeling concept can be represented by an equation of motion, for example. The equation can be reshaped into a state-space form equation for utilization by an integration component. In this regard, the integration component can apply an integration scheme, according to a set of parameters for example, regardless of what equation is used. With the equation in state-space form, the integration scheme can be applied to produce a vector of functions of time related to the equation of motion. In this regard, the integration component can be pluggable into a variety of scenarios. Additionally, equations of motion can be changed without modifying the integration scheme since the formula is still in state-space form, and the integration scheme can change without modifying the modeling concept(s) because it is operating on the same equation regardless. In this way, the two concepts can be separated in a programmatic context.

Additionally, a programming language can be provided that implements at least enough functional support to provide the separation of concepts. In one embodiment, a compiler can provide higher-order or first-class algorithms and concepts to allow an integration component to receive the state-space form equation (or function) as input. In this regard, the separation can be implemented for substantially any state-space function that matches a higher-order/first-class interface of the integration component.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that solves a state-space form equation.

FIG. 2 illustrates a block diagram of an exemplary system that generates time functions by applying an integration scheme to a modeling concept.

FIG. 3 illustrates a block diagram of an exemplary system that simulates an activity using a modeling concept and a separate integration scheme.

FIG. 4 illustrates a block diagram of an exemplary separable integration component.

FIG. 5 illustrates a block diagram of an exemplary system that utilizes separable integration in a programming language context.

FIG. 6 illustrates a block diagram of an exemplary system that produces a declarative function from an imperative function.

FIG. 7 illustrates an exemplary flow chart for applying an integration scheme to a space-state form equation.

FIG. 8 illustrates an exemplary flow chart for creating a declarative function from an imperative function.

FIG. 9 is a schematic block diagram illustrating a suitable operating environment.

FIG. 10 is a schematic block diagram of a sample-computing environment.

### DETAILED DESCRIPTION

Separation of integration and modeling components and/or concepts in simulating physical systems is provided for use in programmable simulation devices and applications. Typically, the concepts are tied in electronics and programming contexts not allowing full appreciation of modifying the concepts separately to achieve desirable results. Modifying integration concepts can selectively provide for more fidelity, stability, and/or performance depending on the modification, and changes to modeling concepts (or equations of motion) can avoid practical limitations of the concepts such as collisions. By separating the concepts, both sets of functionality can be leveraged to provide a desired simulation device or application. Additionally, once modeling functions have been coded and tested, a developer can focus on integration concepts/components to avoid constantly revisiting the complex equations often associated with modeling in simulation contexts.

In one embodiment, desired equations of motion can be reduced to state-space form equations in which an arbitrary system of linear (or non-linear), n-th order partial or ordinary differential equations can be rewritten as equivalent collections of first-order ordinary differential equations. From this form, one or more integration schemes can be applied to produce a rank-N column vector of functions of time; the functions are dynamics that can take a real number and output one or more complex numbers that can be related to simulation statistics at a given time—the function can be chosen based on time, for example. Additional parameters can be provided as input to the integration scheme as well, such as a simulation time interval, an initial value for the rank-N column vector (such as at the first time in the interval, for example), a precision requirement, a performance (or real-time) requirement, a discrete approximate step size for the integration scheme, and/or the like.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

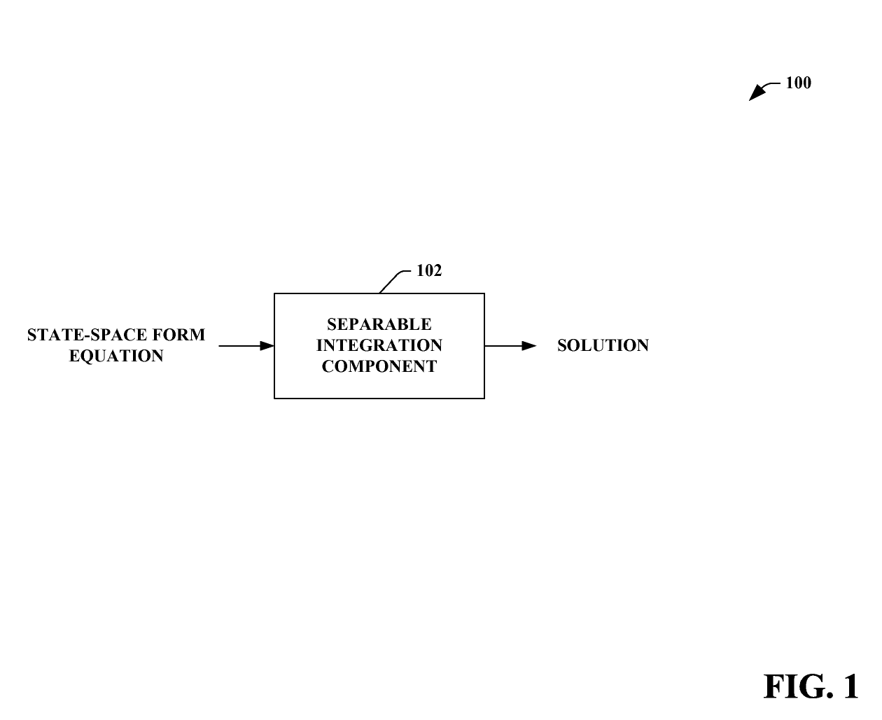

Now turning to the figures, FIG. 1 illustrates a system 100 that facilitates solving a state-space form equation according to an integration scheme. A separable integration component 102 is provided that can take an input, such as a state-space form equation, and produce at least one solution. In one embodiment, the state-space form equation corresponds to a reshaped equation of motion; the separable integration component 102 can solve the equation according to one or more additional parameters. The solution can be a rank-N column vector of functions related to the state-space form equation, for example. The separable integration component 102 can be modular in this regard; it can be plugged into many types of environments for utilization thereof.

The state-space form equation can be of a general form corresponding to the following formula:

$$\frac{d U}{d t} = F ( U , t , Δ t )$$

where t ε [symbol] can model time; At can be a discrete approximate step size, U can be a rank-N column vector of functions of time (having real and/or complex values, for example); and dU/dt can be a time derivative of U (an N-vector function of time, for example). A given equation of motion can be reduced to this form and utilized to facilitate separable integration as described herein. In one embodiment, U and dU/dt can be members of the set of real and complex numbers [symbol] In this regard, F can be a function of three arguments, the first of which is a member of [symbol] and the second and third can be time and delta time, respectively. Because the value of F is a member of [symbol] F can be a member of (( [symbol] )× [symbol] )→ [symbol] ). Thus, the solution can be represented by U ε [symbol] .

One or more integration schemes can be used to solve the state-space equation. Such algorithms can include, but are not limited to, Runge-Kutta, Adams-Moulton, Varlet, Bashford, varying degrees of the algorithms, and/or multi-step schemes, for example. The separable integration component 102 can provide the one or more schemes to offer varying levels of fidelity/stability/performance tradeoffs. For example, the integration schemes that stay close to the modeling equation can require more calculation (and therefore more processing power in simulation devices and applications); the schemes that simplify the modeling equation are not as precise. Thus, a scheme can be chosen to fit a given modeling equation according to, in part, one or more parameters (such as a required performance metric, for example). In one embodiment, a simulation device or application can utilize the separable integration component 102. The device or application can allow input of a performance metric as a sliding scale of detail to performance. For example, a game can provide such a detail setting, and the user can select a point on the scale to obtain truer-to-life detail for trading-off performance or vice versa.

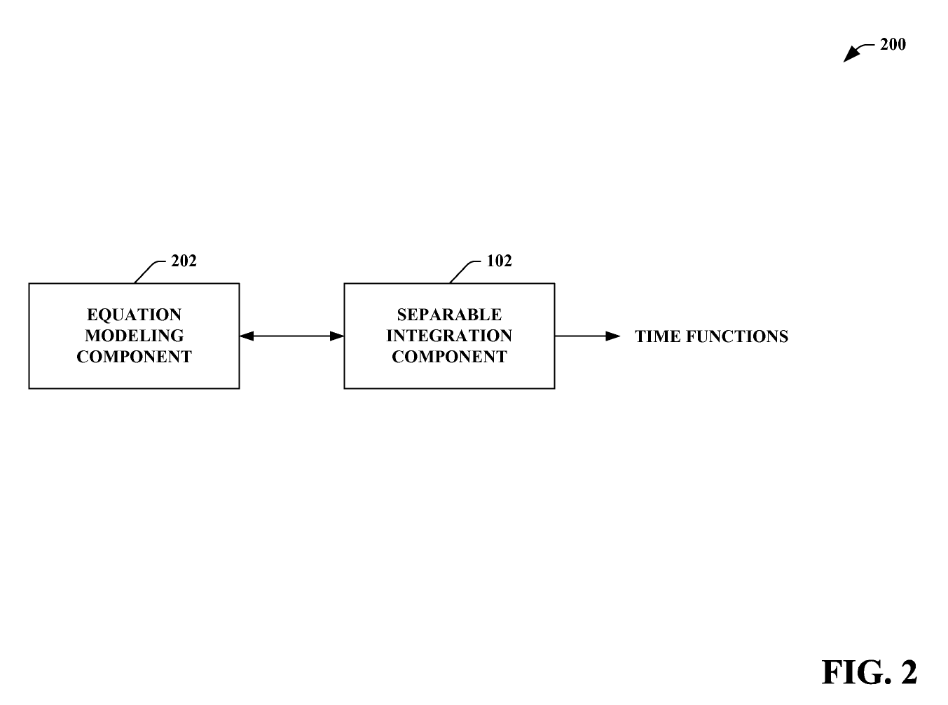

Referring to FIG. 2, a system 200 for providing time functions from a set of equations of motion is displayed using separated integration. In particular, an equation modeling component 202 is provided that can model one or more equations of motion, for example. Additionally, a separable integration component 102 is provided to solve the equation (or a reshaped version thereof) as a set of time functions. In one embodiment, the equation modeling component 202 can model one or more equations of motion for an application, such as a mechanical, electrical circuit, fluid dynamic, a simulation of such concepts, and/or the like. The equation modeling component can reshape the equation of motion into a state-space form, for example, and provide the state-space form equation to the separable integration component 102 for solving thereof. It is to be appreciated that parameters, such as those mentioned supra, can be provided to the separable integration component 102 as well to facilitate context-specific solutions.

In one embodiment, the equation modeling component 202 can model one or more linear or non-linear equations of motion, such as Newton's laws, Hamilton-Jacobi equations, Euler's equations for rigid-body motion, Birkhoff's equations for circuits, Navier-Stoke equations for fluid dynamics, Maxwell's field equations, Klein-Gordon, Yang-Mills, Schrodinger and Dirac equations, and/or the like. One or more of the equations of motion can be reshaped into state-space form for utilization by the separable integration component 102. For example, the following equation for a general component of a resistor-capacitor (RC) circuit and/or Newton's Laws for a spring and dashpot can be utilized in this embodiment.

$$\frac{{d}^{2} x}{d {t}^{2}} = β \frac{d x}{d t} + γ x + u$$

This equation is a general linear second-order system where x and u are functions of time and β and γ are complex coefficients. Utilizing the following formula:

$$Ψ = ( \begin{matrix}\dot{x} \\ x\end{matrix} ) ,$$

where x is shorthand for dx/dt the second-order system shown above can be rewritten as:

$$\frac{d Ψ}{d t} = ( \begin{matrix}\dot{x} \\ x\end{matrix} ) = ( \begin{matrix}β & γ \\ 1 & 0\end{matrix} ) ( \begin{matrix}\dot{x} \\ x\end{matrix} ) + ( \begin{matrix}u \\ 0\end{matrix} ) = M Ψ + U .$$

This is a first-order system of ordinary differential equations. This formula can subsequently be utilized by the separable integration component 102 to facilitate solving the equation for a vector of time functions.

As another example, Euler's equations for rigid-body motion can be reshaped as well. A formula for this equation can be provided as follows:

$$\frac{d ω}{d t} = {I}^{- 1} ( T - ω \times ( I ω ) ) .$$

In this formula, I can be a 3×3 constant moment-of-inertia tensor; ω, which can be an angular velocity vector, and T, which can be torque, can both be 3-vector functions of time, for example. Though this formula is not linear, it is in state-space form and can thus be solved for a time function vector by the separable integration component 102.

In this embodiment, equations of motion can be selected from the equation modeling component 202 and integration schemes can also be selected from the separable integration component 102 to facilitate selecting between stability and performance, for example. In one embodiment, Euler integration can be utilized to simulate forward time. This scheme can approximate U(t+Δ), which is the value of U at the later time t+Δ, given U(t), the value of U at time t, as

$$U ( t ) + Δ \frac{d U}{d t} = U ( t ) + Δ F ( U ( t ) , t )$$

where Δ is the integration step, a small time increment, and F(U(t), t) is F evaluated at time t. Another possible method is the Euler midpoint method, which can approximate U(t+Δ) as

$$U ( t ) + Δ F ( V ( t ) , t + \frac{Δ}{2} )$$

$$where V ( t ) = U ( t ) + \frac{Δ}{2} F ( U ( t ) , t ) .$$

It is to be appreciated that other integration schemes can be utilized by the separable integration component 102 as well to provide time function vectors; these are two examples of such functions. Additionally, the separable integration component 102 can solve substantially any state-space form equation regardless of the application to which it applies. The result can be utilized by the application to provide time specific data using the time function vector(s) provided as output.

Moreover, it is to be appreciated that the subject matter described herein can apply not only to initial value problems, such as equations of motion problems, but also to boundary value problems, Lie algebra problems, and the like as well. In the boundary value problem embodiment, for example, a geometry can be input into the separable integration component 102 instead of an initial value or simulation time. For example, the boundary value problem can be used to solve for a shape of a soap bubble on a twisted wire. In this regard, the equations can be separated from the integration schemes to solve this problem as described above. Additionally, it is to be appreciated that the boundary value problems can be substantially equivalent to abstract-spaced symmetry problems in Lie algebra. Thus, when a boundary value problem exists, a Lie algebra problem can exist as well. Thus, Lie algebra problems can be solved using the bifurcated configuration described above as well.

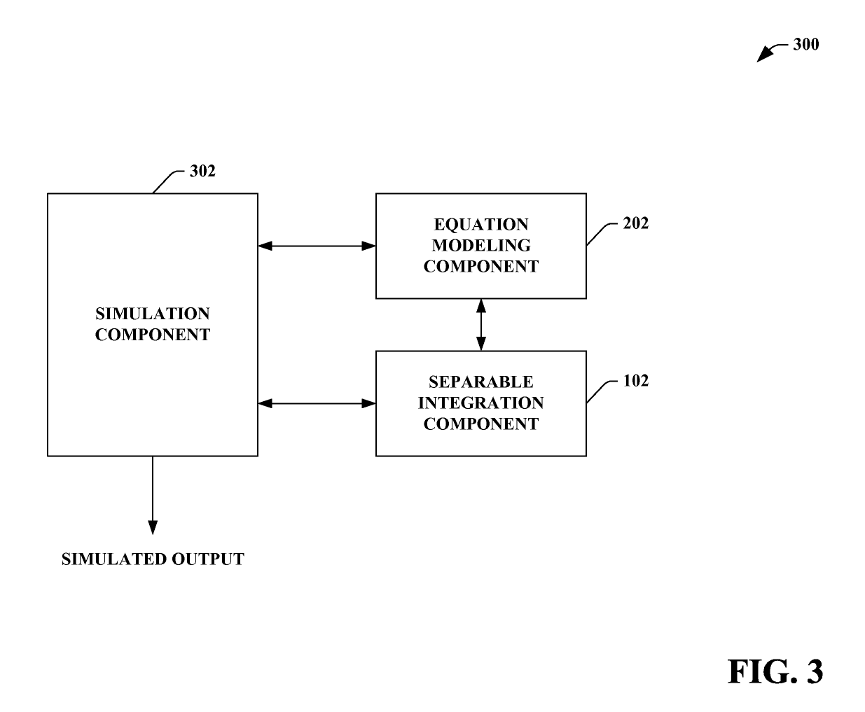

Turning now to FIG. 3, a system 300 for utilizing separable integration for equations of motions in a simulation environment is displayed. A simulation component 302 is provided that can simulate one or more physical systems, for example, and produce a related output. Additionally, an equation modeling component 202 is provided to utilize one or more equations of motion along with a separable integration component 102 that can apply one or more integration schemes to the equations of motion. In one embodiment, the simulation component 302 can desire to utilize an equation of motion to simulate an activity. The equation modeling component 202 can be employed to select an appropriate equation of motion related to the desired activity (and/or the equation modeling component 202 can infer an equation based in part on one or more parameters or behaviors, for example). The equation can be reshaped to a state-space form—this can be performed upon selection and/or at a previous point in time. The separable integration component 102 can subsequently solve the equation based on other parameters that can be provided by the simulation component 302 to produce a vector of time functions to be sent back to the simulation component 302. The simulation component 302 can produce output based on utilization of the time functions in the vector.

As described supra, the equation modeling component 202 can implement numerous equations of motion that can be used by the simulation component 302 depending on the desired action. Once reduced to state-space form, the separable integration component 102 can apply one or more integration schemes to formulate a vector of time functions related to the equation and perhaps a context of the simulation component 302. For example, the simulation component 302 can provide further input to the separable integration component such as a simulation time desired, an initial value for the time function vector at the initial time of the desired simulation time, a precision requirement and/or threshold, a performance requirement (such as a ratio between real-time and simulation time), and the like. Additionally, a discrete approximate step size for the equation can be input. It is to be appreciated that the input could also be specified by the equation modeling component 202 (such as from the simulation component 302, for example). The separable integration component 102 computes the time function vector(s) and provides them to the simulation component 302 for use in providing a simulation output.

The simulation component 302 can be hardware, software, firmware, and/or the like, that models one or more of video games, flight/driving simulators (such as for military and civilian training), biophysics simulators (such as for sports training and/or medicine, for example), queuing simulators (such as for operations/logistics), network simulators (for communication design, diagnosis, and operation, for example), orbit simulators for spacecraft navigation, computer-aided design/computer-aided manufacturing (CAD/CAM) simulators for optics, electronics, mechanical design and manufacture, and/or the like. It is to be appreciated that some simulators can have little performance requirement (slower than real-time), such as electronics, solid-state physics, lasers, nuclear and atomic physics, etc. while some can have stricter performance requirement (faster than real-time), such as deep-space navigation and astrophysics. Additionally, some simulators require great precision, such as magnetic resonance imaging (MRI). Many other simulation systems exist and can utilize the subject matter as described to produce desirable simulations. Considering the multitude of simulations, the separation of equations of motion from integration schemes can allow a developer of such simulation devices and applications to concentrate of refining integration for established equations to provide the desired customization for the simulation context.

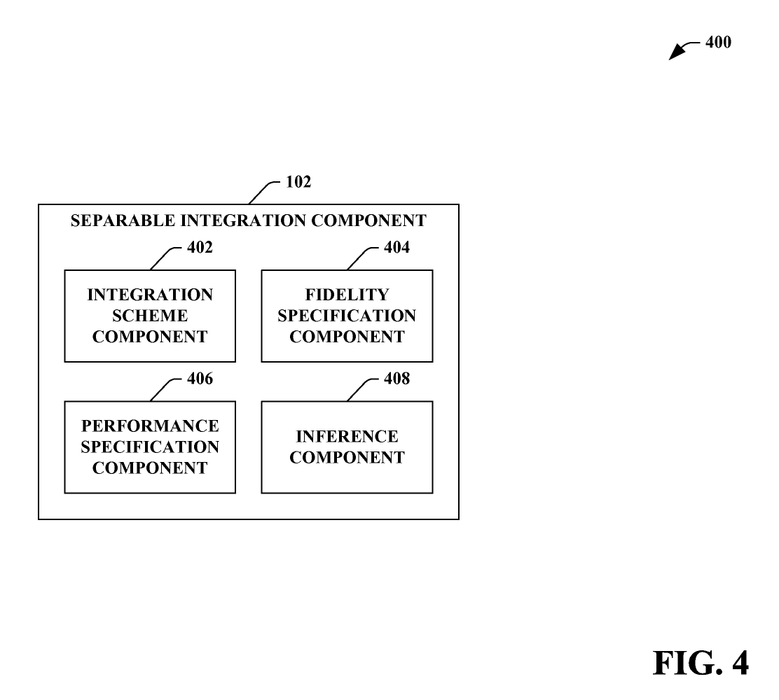

Referring now to FIG. 4, a system 400 that facilitates providing separable integration functionality is illustrated. A separable integration component 102 is shown having an integration scheme component 402 that can store and utilize a plurality of integration schemes to solve state-space form equations, for example, as well as a fidelity specification component 404 and a performance specification component 406 to accept and/or determine requirements for employing one or more integration schemes. Additionally, an inference component 410 is provided to infer one or more of the inputs/outputs and/or logic of the components.

In one embodiment, the integration scheme component 402 can store and apply one or more integration schemes to a state-space form equation. The equation can be modeled and reshaped separately to allow the separable integration component 102 to be modular such that it can be plugged in one or more environments for use therewith. In this regard, the implementation need not take the equation used (such as an equation of motion, for example) into consideration as it already has the state-space form representation. The integration scheme component 402 can apply one or more integration schemes to the state-space form shaping of the equation to produce one or more vectors of time functions, for example.

The fidelity specification component 404 can allow for a parameter related to a fidelity desirability to be specified in a request for use of the separable integration component 102. Additionally, the fidelity specification component 404 can be utilized to automatically provide a fidelity requirement or goal based in part on previous requests, a context for use of the provided equation, the equation itself, etc. Similarly, the performance specification component 406 can allow for similar functionality with respect to a performance requirement or goal. The two components can work together to determine a likelihood of meeting both specifications and/or provide the likelihood or a suggested change/ratio to the requesting entity, for example. The inference component 408 can be utilized, for example, to infer a fidelity and/or performance specification as described supra. Additionally, the inference component 408 can determine one or more schemes to be employed for a given equation and/or environment. For example, heuristics can be used to determine integration schemes to be used based on previous uses in previous contexts, previous uses for previous equations, a mixture of the two, a user or application-based determination and/or the like.

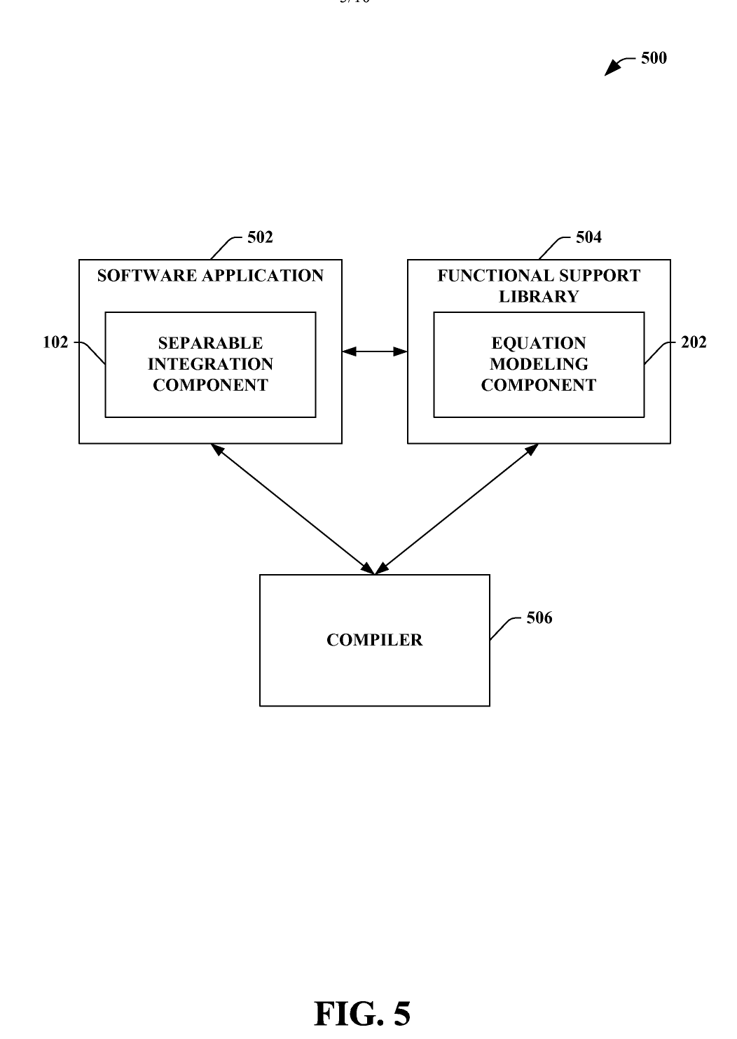

Now referring to FIG. 5, a system 500 is displayed that facilitates implementing functional support for higher-order/first-class algorithms and concepts for an imperative (or object-oriented) programming application. In particular, a software application 502 is provided that comprises a separable integration component 102 for applying an integration scheme to a higher-order or first-class equation. Additionally, a functional support library 504 is provided comprising an equation modeling component 202 that can employ one or more functional higher-order equations. The application 502 and library 504 can be compiled into a machine code (and/or an executable application, library, or the like) by a compiler 506. In one embodiment, the separable integration component 102 can leverage the functional support library 504 to acquire a representation of an equation using the equation modeling component 202. The compiler 506 can have functional support for specifying delegate function (e.g. function pointers), lambda expressions, higher-order/first-class algorithms, etc. Thus, one way to achieve separable integration can be to utilize a delegate function to specify an input into the separable integration component 102—the input can be a state-space form equation or function, for example.

The software application 102 can be an application coded in an imperative environment, such as an object-oriented programming language as described above. A functional element can be provided to the imperative environment by the compiler 506 and can be utilized by the functional support library 504 and software application 502. For example, the equation modeling component 202 of the functional support library can provide a state-space form shape of an equation as input to the separable integration component 102; the separable integration component 102 can take the input as a pointer to the function having the requisite signature of a state-space form function (this functionality can be offered by the compiler 506, for example). The separable integration component 102 can then advance the simulation according to the equation by solving the state-space form equation. The equation modeling component 202 can provide a function of the form:

$$E ≡ ( \frac{d U}{d t} = F ( U , t , dt ) ) .$$

The separable integration component 102 can solve this equation for a time step Δ (by solving for a time function vector and utilizing the element related to the step, or just by solving for the step, for example) and provide a value for U(t+Δ).

For example, the following pseudo-code can be utilized by the functional support library 504 (and/or the equation modeling component 202) to implement Newtonian equations of motion for a massive particle connected to one or more spring-and-dashpot combinations:

```
public class Stone
{
  public double m; // mass
  public SV psi = new SV( );
  public ArrayList sticks = new ArrayList( );
...
```

In this example, SV can represent a state vector, for example, which can be a six-dimensional combination of position and velocity. The ArrayList type can represent a type that supports adjustable-length arrays, for instance. The Stone class can also have the following function that can compute F(U, t, dt) to create a state-space form equation.

| public SV psiPrimeDt(SV psi, double t, double dt) | |
|---|---|
| { | |
| SV psi2 = new SV( ); | // its two 3-vectors are x (position) and |
| | // v (velocity) |

| psi2.x = psi.v * dt; // kinematic 3-vector calculation | |
|---|---|
| Vec3 f = new Vec3( ); // new force vector starts off at zero | |
| for (int i = 0; i < sticks.Count( ); i++) | // stone has any |
| | // number of sticks |

| | |
|---|---|
| { | |
| Stick k = ((Stick)(sticks[i])); | // stick knows its two |
| | // stones, “stone1” and |
| | // “stone2” |

| | |
|---|---|
| if (this == k.stone2) | |
| f = f + k.force(psi, k.stone1.psi); | // stick knows how to |
| | // compute its force |

```
    else
      f = f + k.force(psi, k.stone2.psi);
  }
  psi2.v = (f / m) * dt; // Newton's 2d law, straight-up
  return psi2;
}
```

Thus, this function takes a state vector (SV) as input, which can correspond to U, as well as a double t, and a double dt like the state-space form equation shown above, and returns an SV as well. Thus, the machine looks like that described supra with respect to state-space form and set members, ((R→C^{N})∴R×R)<(R→C^{N}).

When the equation of motion (or modeling concept, boundary value problem, or Lie algebra problem) is in this form, it can be integrated with software application 502 by utilizing the modular separable integration component 102. In this regard, a delegate function (e.g. a function pointer) can be supported by the compiler 506 and defined to represent functions in the state-space form having the following signature, for example.
public delegate SV pptt(SV p, double t, double dt);
   The function can be implemented as shown above, or using substantially any function that takes an SV and two doubles and returns an SV. Desirably, the function can relate to one or more equations of motion, for example. Additionally, substantially any higher-order/first class algorithms and concepts can be used in this embodiment. Regardless, an integration function, defined and utilized by the separable integration component 102 in software application 502, can utilize the pointer to receive the state-space form function and solve for a vector of time functions (or just solve the function for a given time increment, for example). One such function can be the following, for example.

```
public void stepSim(pptt F, double t, double dt, string method)
{
  if (method == “midpoint Euler”)
  {
    SV k1 = F(psi, t, dt);
    SV k2 = F(psi + k1, t + dt, dt);
    psi = psi + (k1 + k2) / 2;
  }
  else if (method == “Euler”)
  {
    psi = psi + F(psi, t, dt);
  }
  else if (method == “Runge-Kutta 4”)
  {
    SV k1 = F(psi, t, dt);
    SV k2 = F(psi + k1 / 2, t + dt / 2, dt);
    SV k3 = F(psi + k2 / 2, t + dt / 2, dt);
    SV k4 = F(psi + k3, t + dt, dt);
    psi = psi + (k1 + 2 * k2 + 2 * k3 + k4) / 6;
  }
}
```

This function can use one of three integration schemes (midpoint Euler, Euler, and Runge-Kutta 4), as shown. The function can take the state-space form function pptt as input providing the notion of higher-order function necessary to separate modeling components from integration component, for example. It is to be appreciated that this is just one possible implementation and implementations are not limited to string inputs regarding the methods. For example, abstraction and inheritance can be utilized to make separate classes for a set of integration schemes; as well, an enumeration can be utilized in place of a string in the method above, an implementable interface (e.g. IIntegrationlnterface, etc.) can be provided, and so on to select one or more integration schemes. Additionally, many more integration schemes of varying complexity can be implemented as well. Moreover, it is to be appreciated that the functionality of the separable integration component 102 can be implemented in hardware and/or firmware as well; the disclosed subject matter is not limited to software applications.

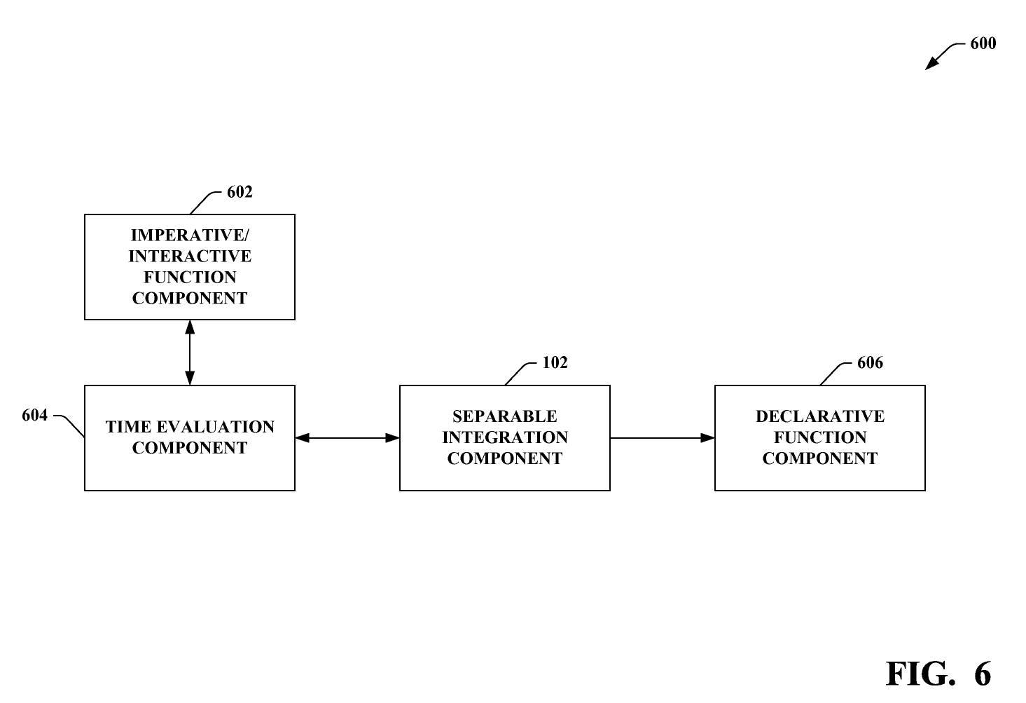

Turning, now, to FIG. 6, a system 600 for evaluating imperative or interactive functions as declarative is shown. An imperative/interactive function component 602 is provided that defines one or more imperative/interactive functions. A time evaluation component 604 is also provided to evaluate and/or determine values of the imperative/interactive function at given points in time (past or future). In addition, a separable integration component 102 is provided to apply an integration scheme to time evaluated data along with a declarative function component 606 that can define a declarative function based application of an integration scheme. In one embodiment, the imperative/interactive function component 602 can provide an imperative/interactive function that can be evaluated at a number of points in time by the time evaluation component 604. The values at the given times can be input into a separable integration component 102 and applied to an integration scheme to create simulation data, for example. The data, or a permutation thereof, can be sent to the declarative function component to define a declarative function based in part on the data. In this regard, functional reactive programs can be created, for example.

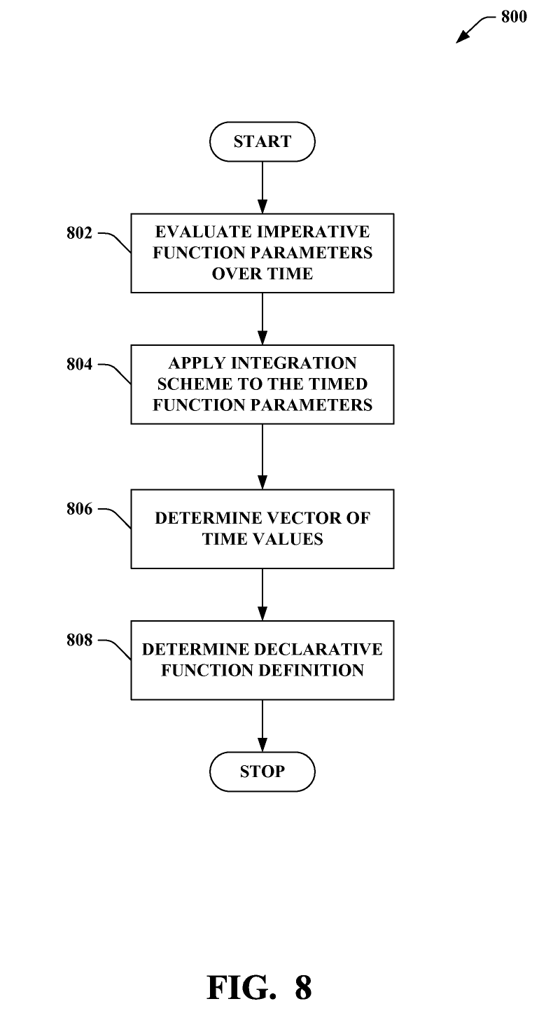

Many things (real-world and/or digital/computerized things) can be considered as a function of movement over time; for example, media items, such as animations and music, can be considered as a function of images and/or musical notes over time. Likewise, for instance, mouse movement can be considered as a function of screen position over time. Thus, at time to, the mouse cursor can be at (x₀, y₀) on a display, and at time t₁, the mouse can be at (x₁, y₁). The functions that effectuate mouse movement can be implemented as an imperative/interactive function in the imperative/interactive function component 602, for example. The time evaluation component 604 can model the behavior of the mouse, such as the parameters of the mouse (e.g. screen position in this example) and create a vector of the time-based information. This can be input into the separable integration component 102 for application of an integration scheme thereto. It is to be appreciated that the integration scheme can be one or more of those described supra or others not mentioned, for example, as long as it can output a time function vector or a value at a given point in time. This information can be sent to the declarative function component 606 to be utilized in evaluating the data as a declarative function. For example, a vector of positions (as determined from the original imperative/interactive function as shown) can be evaluated to determine time-based movement. In this regard, rather than merely detecting movement in an (x, y) single time space, more sophisticated movement can be evaluated. Such movements that can be evaluated given multiple positions in time can be like a swirl movement, a quick flick movement, a FIG. 8 movement, or substantially any other movement that can be evaluated by multiple positions over time. This functional reactive functionality can be useful in providing multiple functionalities for a single device or application, for example.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

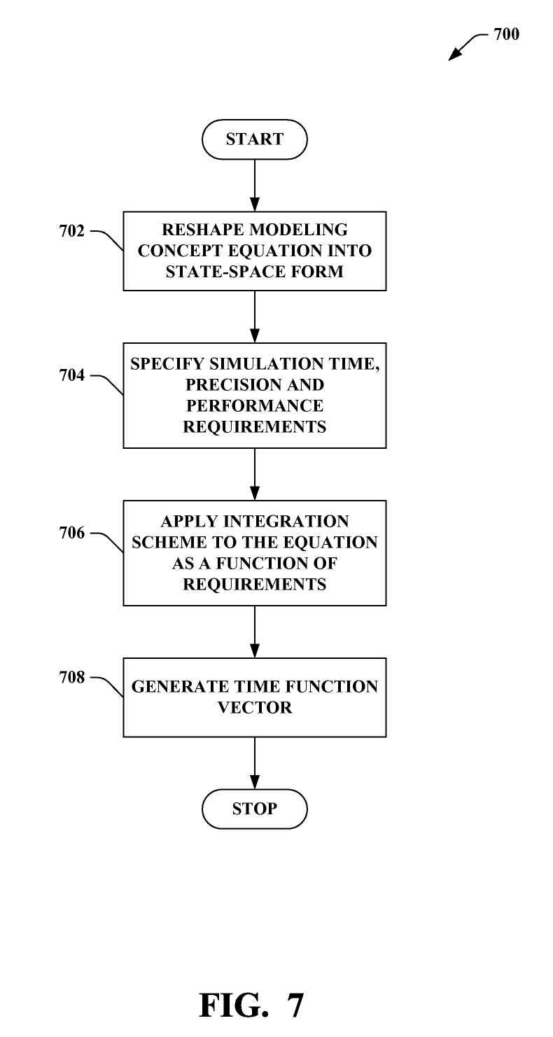

In view of the exemplary systems described supra, methodologies that may be implemented in accordance with the disclosed subject matter will be better appreciated with reference to the flow charts of FIGS. 7-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 7 shows a methodology 700 for applying separable integration to an equation (such as an equation of motion, for example). This can occur in simulation environments for initial value problems, boundary value problems, Lie algebra problems, and/or the like. The simulation environments can be implemented as hardware, software, and/or firmware, for example, that can specify various performance and precision requirements. The simulation environments can be those as described supra or other environments not listed that utilize an equation of motion that can be applied to an integration scheme to produce a time function value and/or vector. At 702, a modeling concept equation (or equation of motion, boundary value problem, Lie algebra problem, etc.) can be reshaped into a state-space form equation. In this regard, integration schemes can be modular since they are not concerned with what they are solving as long as the function is in a solvable form. Thus, one or more equations of motion (or other modeling concept equation) can be perfected and solidified allowing a simulation developer to concentrate on how to integrate the equation of motion to provide a desired simulation. It is to be appreciated that integration schemes can change and different schemes can be applied to achieve a desired performance or resource usage, for example.

At 704, parameters for integrating the state-space form equation can be specified such as a simulation time that defines the time interval for the simulation using the equation of motion. A precision requirement can also be provided to ensure the simulation does not fall below the requirement; this can be crucial in mission critical simulators, for example, such as aerospace and health-related simulators, for example. Additionally, a performance requirement can be specified, which can be a ratio of real-time to simulation time. This can ensure the simulation is completed in a given real-time interval. It is to be appreciated that a precision requirement and a performance requirement can be conflicting for a given environment such that both cannot be met (if they are demanding, for example) in the environment. Such disparities can be handled in numerous ways, such as notification to the requester, a suggestion regarding acceptable values, etc. At 706, an integration scheme is applied to the equation as a function of the parameters (such as a scheme as described supra); for instance, the equation can be evaluated corresponding to the parameters specified to produce rank-N column vector of time functions. It is to be appreciated that the equation can be solved as a vector of time functions (and/or for a given time instance). The time function vector is generated at 708. This can be utilized to solve the equation of motion, according to the integration scheme, at a particular point in time, for example.

FIG. 8 shows a methodology 800 for determining a declarative function, or one or more values thereof, from an imperative function. As described, this can be in the context of substantially any imperative function whose values can be evaluated at a given point in time (e.g. as a function of time). In this regard, time-based aspects of the imperative function can be determined to increase functionality. As described above, multiple positions of an input device over time can define a number of movements with regard to the device to facilitate more interactive understanding of device movements, for example. At 802, parameters of an imperative function are evaluated over time to determine value at given points in time. This can facilitate associating the time with the values such to further analyze how the values change giving the function a declarative or functional reaction aspect, for example. At 804, an integration scheme, such as described above, can be applied to the time evaluated parameters to facilitate defining a movement or other property over time. For example, using the integration scheme, values can be obtained over time with respect to other values of the function to determine a progression over a given time interval.

At 806, this information can be utilized to determine a vector of time values, for instance. The vector can also be utilized to provide a value of the imperative function over time. At 808, a declarative function definition or a declarative aspect of the imperative program or function can be determined or defined based on the time values related to the imperative program or function. In one embodiment, for example, an animation can be defined as a function of pictures over time, for example. The animation can occur according to the integration scheme, for instance.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

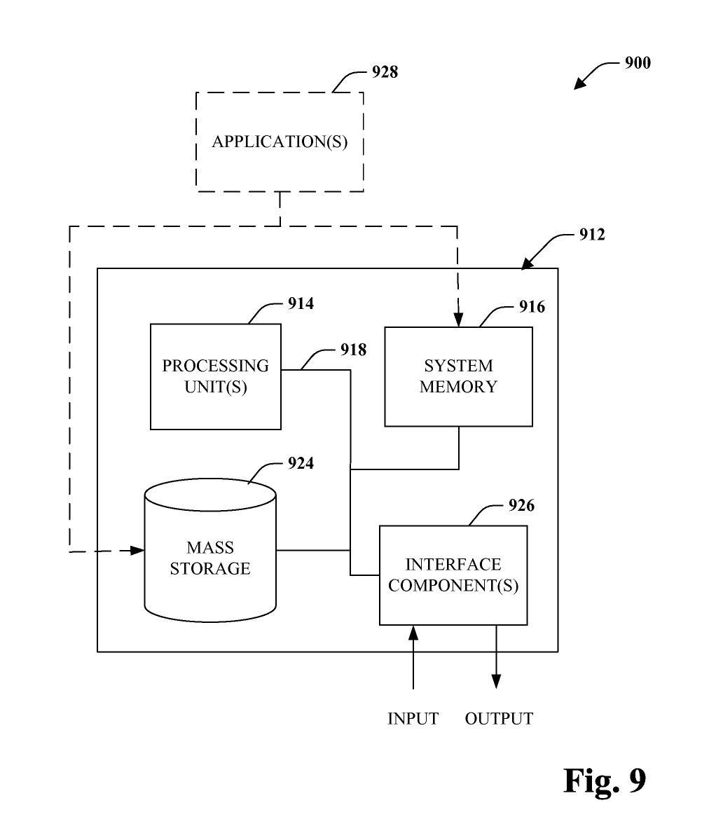

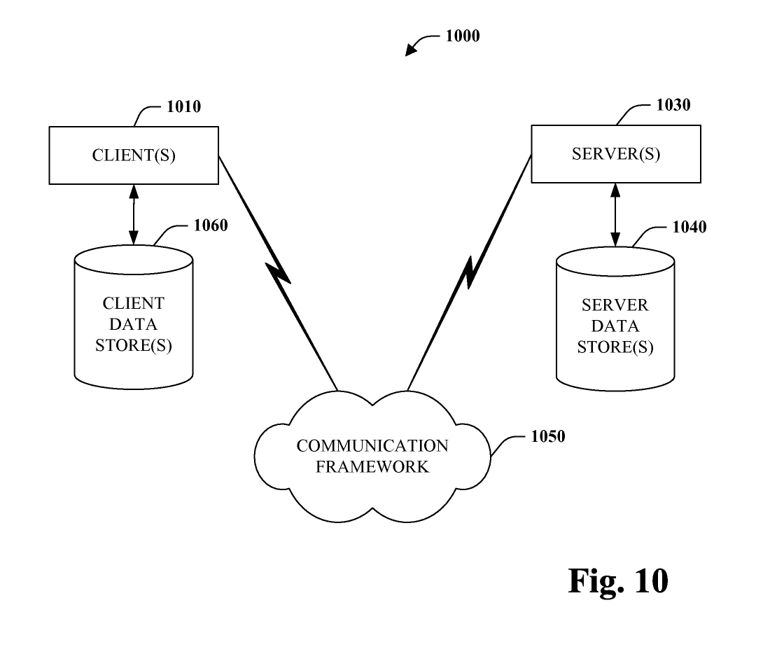

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 900 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 900. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. Here, the client(s) 1010 can correspond to program application components and the server(s) 1030 can provide the functionality of the interface and optionally the storage system, as previously described. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

By way of example, a remote library or centralized simulation service can be provided on one or more server(s) 1030. The data store(s) 1040 can house one or more equations that can be used to perform a simulated activity. Such equations can be equations of motion, for example, and/or the like. One or more client(s) 1010 can implement separable integration in a plurality of formats including software, hardware, firmware, etc. The client(s) 1010 can request state-space form equations from the server(s) 1030 over communication framework 1050, for example, and can utilize the equations to apply an integration scheme according to parameters specified for a given environment (such as a simulation environment, for example). The client(s) 1010 can additionally store one or more integration schemes in a data store 1060 for selective utilization thereof according to one or more environment variables, for example.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for providing separable integration for simulation environments, comprising:
an equation modeling component that reshapes an equation of motion for a simulation environment into a state-space form equation; and
a separable integration component that applies at least one integration scheme to the state-space form equation to produce a vector of functions of time related to the simulation environment.

2. The system of claim 1, further comprising a simulation component that implements the simulation environment and provides a simulation output related to at least one function in the vector of functions of time.

3. The system of claim 1, the separable integration component applies the at least one integration scheme based on at least one parameter.

4. The system of claim 3, the parameter is at least one of a simulation time interval, a precision specification, and/or a performance time requirement.

5. The system of claim 1, further comprising an imperative programming language compiler that implements higher-order concept support.

6. The system of claim 5, further comprising a software application that is implemented in the imperative programming language and leverages the higher-order concept support compiler to implement the separable integration component.

7. The system of claim 6, the equation modeling component passes the state-space form equation to the implemented separable integration component as a higher-order concept algorithm.

8. The system of claim 6, the implemented separable integration component provides at least one of enumerations, separate implementable classes, or interfaces to select the integration scheme.

9. The system of claim 6, the implemented separable integration component can accept one or more parameters that specify a geometry for a boundary value problem.

10. The system of claim 1, further comprising an inference component that can automatically select an integration scheme based on one or more analysis heuristics.

11. A method for providing separable integration for simulation environments, comprising:
computing a state-space form equation for a modeling equation;
determining at least one parameter related to context of a simulation environment; and
applying an integration scheme to the state-space form equation based at least in part on the parameter.

12. The method of claim 11, the integration scheme is selected based at least in part on the context of the simulation environment.

13. The method of claim 11, further comprising selecting the modeling equation based at least in part on the context of the simulation environment.

14. The method of claim 11, the parameter specifies a simulation time related to the simulation environment.

15. The method of claim 11, the modeling equation corresponds to a sample of parameters over time of an imperative function.

16. The method of claim 11, further comprising switching to a new integration scheme and applying the new integration scheme to the state-space form equation.

17. The method of claim 11, further comprising implementing a software application that applies the integration scheme to the state-space form equation, the software application leverages functional support in a compiler to receive the state-space form equation as input.

18. The method of claim 17, further comprising utilizing a software library to obtain the modeling equation or the state-space form of the modeling equation.

19. A system for providing separable integration, comprising:
means for selecting an integration scheme to apply to a state-space form equation;
means for applying the integration scheme to the state-space form equation, regardless of an equation from which the state-space form equation was computed, to provide a vector of functions of time related to the equation; and
means for solving at least one function of time in the vector of functions of time for a specific time.

20. The system of claim 19, further comprising means for defining a declarative function related to the equation based at least in part on the solution to the at least one function of time.
